(19) United States
(12) Patent Application Publication
(10) Pub. No.: US 2007/0079586 A1
(43) Pub. Date: Apr. 12, 2007

(54) Multi-cyclone dust collector for vacuum cleaner

(75) Inventor: Tak-soo Kim, Gwangju-city (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/437,037

(22) Filed: May 19, 2006

(30) Foreign Application Priority Data
Oct. 11, 2005 (KR) 10-2005-0095417
Oct. 19, 2005 (KR) 10-2005-0098773

(51) Int. Cl. B01D 45/12

(52) U.S. Cl. 55/345

(57) ABSTRACT

A multi-cyclone dust collector for a vacuum cleaner includes a first cyclone unit forcing contaminants-laden air to form an upwardly whirling air current so as to centrifugally separate contaminants from the contaminants-laden air, the first cyclone unit having an air communicating member; a second cyclone unit being disposed under the first cyclone unit, the second cyclone unit forcing partially cleaned air discharged through the air communicating member to be sucked into a lower portion of the second cyclone unit and to form a second upwardly whirling air current so as to centrifugally separate fine contaminants from the partially cleaned air, the second cyclone unit having a plurality of second cyclones; and a contaminants discharging member being disposed over the second cyclone unit inside the air communicating member for discharging the fine contaminants separated in the second cyclone unit to an upper side of the air communicating member.

### CROSS-REFERENCE TO RELATED APPLICATIONS

This application claims the benefit under 35 U.S.C. § 119(a) from Korean Patent Applications No. 2005-95417, filed Oct. 11, 2005 and No. 2005-98773, filed Oct. 19, 2005 in the Korean Intellectual Property Office, the disclosure of both of which are incorporated herein by reference in its entirety.

### BACKGROUND OF THE INVENTION

1. Field of the Invention

The present invention relates to a vacuum cleaner. More particularly, the present invention relates to a multi-cyclone dust collector for a vacuum cleaner for separating contaminants from sucked air.

2. Description of the Related Art

Generally, a vacuum cleaner generates a suction force by a vacuum generator including an impeller and a motor. Contaminants such as dust or dirt on a cleaning surface are sucked into the vacuum cleaner with outside air by the suction force. When sucked contaminants and outside air pass through a dust collecting apparatus that is disposed in a main body of the vacuum cleaner, contaminants are separated and collected. Thereafter, clean air is discharged outside the main body of the vacuum cleaner.

Dust collecting apparatus that separates and collects contaminants from outside air may employ a dust bag, a cyclone dust collector, and so on. Currently, cyclone dust collectors providing semi-permanent use have become widespread.

A conventional cyclone dust collector includes a cylindrical cyclone body in which sucked air and contaminants whirl, an air inlet port, and an air-discharging port. The air inlet port is disposed at a top end of a side surface of the cyclone body in a substantially tangential direction to the cyclone body so that sucked air whirls downwardly easily. The air-discharging port is disposed on a top end of the cyclone body so as to guide air, which whirls downwardly and rises up inside the cyclone body, outside the cyclone dust collector.

However, in the conventional cyclone dust collector, the air whirling downwardly certainly collides with the air rising up inside the cyclone body because both of the air inlet port and the air discharging port are disposed at an upper portion of the cyclone body. Therefore, the conventional cyclone dust collector has a low contaminants collecting efficiency due to collision between the rising air and the descending air.

Furthermore, the conventional cyclone dust collectors cannot separate fine contaminants. In order to overcome the problem described above, it has been developed a multi-cyclone dust collector that separates fine contaminants from the sucked air in two steps so as to provide a higher contaminants collecting efficiency, in Korean Patent Application No. 10-2003-0062520 (filed Sep. 8, 2003). However, the conventional multi-cyclone dust collector still has a problem: contaminants collecting efficiency is decreased due to collision between the rising air and the descending air. Also, the conventional multi-cyclone dust collector has a large size, especially a large height because the number of cyclones is increased.

Furthermore, because the conventional multi-cyclone dust collector has a contaminants receptacle that is disposed under the cyclone body to share a space of the cyclone body, contaminants collected in the contaminants receptacle are flowed back to the air discharging port by the air that whirls downwardly and rises up inside the cyclone body. Therefore, a contaminants collecting efficiency is decreased.

### SUMMARY OF THE INVENTION

The present invention has been developed in order to overcome the above drawbacks and other problems associated with the conventional art. An aspect of the present invention is to provide a multi-cyclone dust collector that can separate fine contaminants and has a high contaminants collecting efficiency.

Another aspect of the present invention is to provide a multi-cyclone dust collector that can discharge contaminants through an upper side thereof for the convenience of emptying contaminants.

Still another aspect of the present invention is to provide a compact multi-cyclone dust collector having a shorter height than the conventional multi-cyclone dust collector.

The above aspects and/or other feature of the present invention can substantially be achieved by providing a multi-cyclone dust collector for a vacuum cleaner, which includes a first cyclone unit forcing contaminants-laden air to form an upwardly whirling air current so as to centrifugally separate contaminants from the contaminants-laden air, the first cyclone unit having an air communicating member; a second cyclone unit being disposed under the first cyclone unit, the second cyclone unit forcing partially cleaned air discharged through the air communicating member to be sucked into a lower portion of the second cyclone unit and to form a second upwardly whirling air current so as to centrifugally separate fine contaminants from the partially cleaned air, the second cyclone unit having a plurality of second cyclones; and a contaminants discharging member being disposed over the second cyclone unit inside the air communicating member for discharging the fine contaminants separated in the second cyclone unit to an upper side of the air communicating member.

The first cyclone unit further comprises: a first cyclone body being formed in a substantially hollow cylindrical shape, inside which the entered contaminants-laden air whirls; a first contaminants chamber wrapping around the first cyclone body to collect contaminants discharged from the first cyclone body; and an air suction pipe being disposed at a lower portion of the first cyclone body to form the contaminants-laden air into an upwardly whirling air current.

Here, the air suction pipe is disposed to be tangential to the first cyclone body in an upwardly inclined direction and in fluid communication with the first cyclone body.

The first cyclone body further comprises a contaminants discharging opening that is formed at an upper portion of a sidewall of the first cyclone body to discharge contaminants separated from the contaminants-laden air to the first contaminants chamber.

The second cyclone unit further comprises a second contaminants chamber being wrapped around by the plurality of second cyclones to collect fine contaminants discharged from the plurality of second cyclones.

Each of the plurality of second cyclones comprises: a second cyclone body being formed in a substantially hollow cylindrical shape with a closed bottom end, the second cyclone body having a second air suction port that is disposed at a lower portion of the second cyclone body for the air to be entered; and an air-discharging pipe being projected upwardly on a center of a bottom surface of the second cyclone body to discharge air having fine contaminants removed in the second cyclone body.

The plurality of second cyclone bodies and the contaminants discharging member are formed integrally by an injection molding process.

The contaminants discharging member comprises: a contaminants gathering part being disposed under the air communicating member to cover the plurality of second cyclones in a dome shape; and a discharging part being disposed inside the air communicating member, the discharging part having a top end to be extended to the top end of the air communicating member and a bottom end in fluid communication with the contaminants gathering part.

The multi-cyclone dust collector further comprises an upper cover detachably covering a top end of the first cyclone unit.

According to an embodiment of the present invention, a multi-cyclone dust collector for a vacuum cleaner comprising a first cyclone unit for separating contaminants from outside air, and a second cyclone unit for separating fine contaminants from partially cleaned air discharged from the first cyclone unit. The multi-cyclone dust collector comprises the first cyclone unit having at least one first cyclone; and the second cyclone unit having at least one second cyclone, the second cyclone unit being disposed inside the at least one first cyclone of the first cyclone unit; wherein bottom surfaces of the first and second cyclone units is located on the same horizontal plane.

The second cyclone unit comprises a plurality of second cyclones arranged in a substantially circular shape, wherein contaminants separated in the at least one first cyclone of the first cyclone unit are discharged outside a circumferential surface of the at least one first cyclone, wherein contaminants separated in each of the plurality of second cyclones of the second cyclone unit are discharged to a space wrapped around by the plurality of second cyclones.

Each of the at least one first cyclone of the first cyclone unit and the at least one second cyclone of the second cyclone unit forces air to be entered into a side of a lower portion thereof and to be discharged through a center of the lower portion thereof.

With a multi-cyclone dust collector for a vacuum cleaner according to an embodiment of the present invention, in both of a first cyclone unit and a second cyclone unit, sucked air and discharging air do not collide with each other so that contaminants collecting efficiency of the multi-cyclone dust collector is higher than of the conventional multi-cyclone dust collector.

With a multi-cyclone dust collector for a vacuum cleaner according to an embodiment of the present invention, when sucked contaminants-laden air passes through a first cyclone unit, large contaminants are separated, and then, when contaminants-laden air passes through a second cyclone unit, fine contaminants are separated. Therefore, a multi-cyclone dust collector for a vacuum cleaner according to the present invention can separate and collect fine contaminants.

With a multi-cyclone dust collector for a vacuum cleaner according to an embodiment of the present invention, a space in which an upwardly whirling air current is formed is isolated from a space in which contaminants are collected in both of first and second cyclone units so that contaminants collecting efficiency is increased.

With a multi-cyclone dust collector for a vacuum cleaner according to an embodiment of the present invention, the number of parts and time for assembling the multi-cyclone dust collector can be reduced because a contaminants discharging member and a plurality of second cyclone bodies can be molded integrally, and a bottom cover and a plurality of air-discharging pipes can be molded integrally by injection molding. Therefore, manufacturing cost is decreased.

With a multi-cyclone dust collector for a vacuum cleaner according to an embodiment of the present invention, a compact multi-cyclone dust collector can be provided because a second cyclone unit is disposed inside a first cyclone unit, and bottom ends of the first and second cyclone units are located on the same horizontal plane. In this manner, height of the multi-cyclone dust collector can be reduced.

With a multi-cyclone dust collector for a vacuum cleaner according to an embodiment of the present invention, there is a backflow preventing dam so that when a vacuum cleaner is inclined or turned upside down, the backflow preventing dam prevents contaminants collected in a first contaminants chamber from flowing back into a first cyclone body.

With a multi-cyclone dust collector for a vacuum cleaner according to an embodiment of the present invention, an upper cover is opened to empty contaminants. Therefore, it is convenient for a user to empty contaminants collected in both of first and second contaminants chambers.

Other objects, advantages and salient features of the invention will become apparent from the following detailed description, which, taken in conjunction with the annexed drawings, discloses preferred embodiments of the invention.

### BRIEF DESCRIPTION OF THE DRAWING

These and/or other aspects and advantages of the invention will become apparent and more readily appreciated from the following description of the embodiments, taken in conjunction with the accompanying drawings of which:

FIG. 1 is a perspective view illustrating a multi-cyclone dust collector for a vacuum cleaner according to an embodiment of the present invention;

FIG. 2 is an exploded perspective view illustrating the multi-cyclone dust collector of FIG. 1;

FIG. 3 is a perspective view illustrating a bottom cover of the multi-cyclone dust collector of FIG. 1;

FIG. 4 is a sectional view of the multi-cyclone dust collector of FIG. 1 taken along a line IV-IV in FIG. 1;

FIG. 5 is a sectional view of the multi-cyclone dust collector of FIG. 4 taken along a line V-V in FIG. 4;

FIG. 6 is a sectional view of the multi-cyclone dust collector of FIG. 1 when emptying contaminants; and

FIG. 7 is a view illustrating an example of a vacuum cleaner having a multi-cyclone dust collector according to an embodiment of the present invention.

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present invention will be described in detail with reference to the accompanying drawings.

The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise description of exemplary embodiments of the present invention.

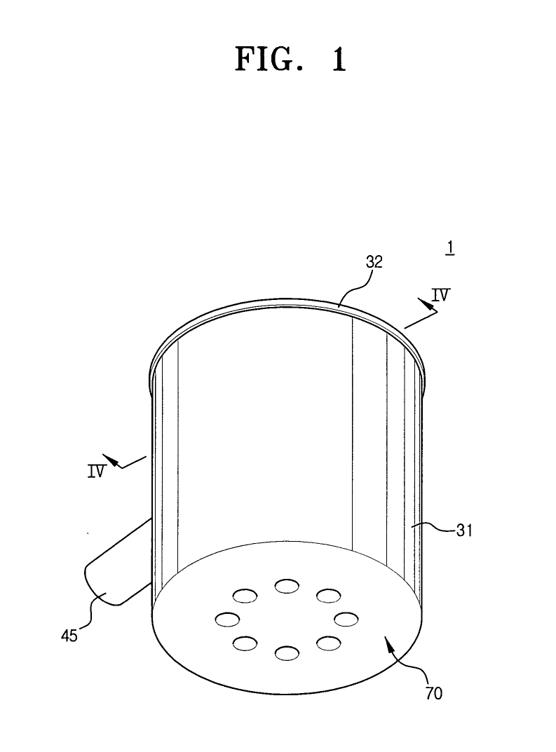

Referring to FIGS. 1 to 4, a multi-cyclone dust collector 1 for a vacuum cleaner according to an embodiment of the present invention includes a first cyclone unit 10, a second cyclone unit 50, and a contaminants discharging member 90.

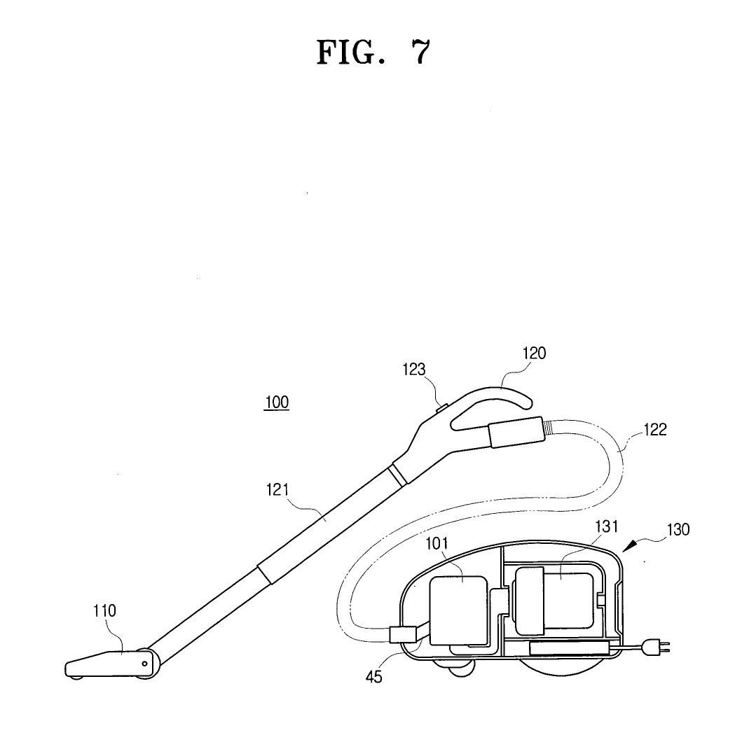

The first cyclone unit 10 takes outside air, which contains contaminants such as dust, dirt and so on and is sucked into a suction brush 110 (see FIG. 7) (hereinafter, referred to as “contaminants-laden air”), and forces the outside air to enter through a lower portion of the first cyclone unit 10 and to whirl upwardly so that contaminants are separated from the contaminants-laden air by centrifugal force operating upon the whirling of the contaminants-laden air. In other words, outside air enters the lower portion of the first cyclone unit 10, which forms the contaminants-laden air into an upwardly whirling air current, thereby centrifugally separating contaminants from the contaminants-laden air.

The first cyclone unit 10 includes a first cyclone body 20, an air communicating member 40, a first contaminants chamber 30, and an air suction pipe 45.

The first cyclone body 20 is a substantially hollow cylindrical shape with a partition wall 22. Contaminants-laden air enters through the air suction pipe 45, and then, forms an upwardly whirling air current in an upper space 23 over the partition wall 22 of the first cyclone body 20. Abottom space 39 that is formed in a substantially cylindrical shape and is wrapped around by a sidewall 21 of the first cyclone body 20 is formed under the partition wall 22 of the first cyclone body 20. The second cyclone unit 50 is disposed in the bottom space 39.

An upper side of the first cyclone body 20 is covered by an upper cover 32. A contaminants discharging opening 24 is formed between a top end of the sidewall 21 of the first cyclone body 20 and the upper cover 32. Contaminants that are separated from contaminants-laden air by centrifugal force are discharged to the first contaminants chamber 30 through the contaminants discharging opening 24. Preferably, the upper cover 32 is detachably mounted on a first contaminants receptacle 31.

Furthermore, a backflow preventing dam 37 is preferably disposed on an inner surface of the upper cover 32 to prevent contaminants collected in the first contaminants chamber 30 from being flowed back into the first cyclone body 20 through the contaminants discharging opening 24 when the multi-cyclone dust collector 1 is inclined. The backflow preventing dam 37 is preferably formed in a substantially cylindrical shape having a larger diameter than a diameter of the first cyclone body 20.

The air communicating member 40 discharges air that has contaminants removed from contaminants-laden air in the first cyclone body 20 by centrifugal force (hereinafter, referred to as “semi-clean air”) to the second cyclone unit 50. The air communicating member 40 is formed in a substantially hollow cylindrical shape, and is projected upwardly on a center of the partition wall 22 of the first cyclone body 20. The air communicating member 40 is extended to the inner surface of the upper cover 32. Therefore, a top end of the air communicating member 40 is closed by the upper cover 32, and a bottom end of the air communicating member 40 is opened. Also, the air communicating member 40 has on a circumferential surface thereof a plurality of discharging holes 43 through which the semi-clean air is discharged. The plurality of discharging holes 43 have a diameter that is small enough to filter large contaminants flowing to the air communicating member 40 in the semi-clean air. Here, even though the air communicating member 40 according to this embodiment of the present invention has the top end 41 reaching the upper cover 32, this is for illustrative purposes only. Alternatively, the air communicating member 40 may have the top end 41 separated from the upper cover 32 so as to be open.

The first contaminants chamber 30 is disposed to wrap around the first cyclone body 20 and to collect contaminants discharged from the first cyclone body 20. The first contaminants chamber 30 is formed as a space between the sidewall 21 of the first cyclone body 20 and the first contaminants receptacle 31 that wraps around the first cyclone body 20 in a substantially cylindrical shape. The upper cover 32, which covers the top end of the first cyclone body 20, forms a top surface of the first contaminants chamber 30. A bottom cover 70 described below closes bottom ends of the first contaminants chamber 30 and a second contaminants chamber 80. Therefore, the bottom cover 70 forms a bottom surface of the first contaminants chamber 30.

The air suction pipe 45 is in fluid communication with the suction brush 110 and is disposed at a lower portion of the first cyclone body 20 so that contaminants-laden air entered into the first cyclone body 20 forms an upwardly whirling air current. In other words, the air suction pipe 45 is disposed to be tangential to the first cyclone body 20 in an upwardly inclined direction and in fluid communication with the first cyclone body 20 so that the contaminants-laden air sucked from the suction brush 110 forms the upwardly whirling air current inside the first cyclone body 20. Furthermore, a sloping surface 27 is formed with an upward inclination on the partition wall 22 of the first cyclone body 20 to where the air suction pipe 45 is connected. The sloping surface 27 assists contaminants-laden air that is entered into the first cyclone body 20 through the air suction pipe 45 to easily form an upwardly whirling air current. The air suction pipe 45 is connected to the sidewall 21 of the first cyclone body 20 through a lower portion of the first contaminants chamber 30.

The second cyclone unit 50 takes semi-clean air discharged from the first cyclone unit 10, and forces the semi-clean air to enter through a lower portion of the second cyclone unit 50 and to whirl upwardly inside the second cyclone unit 50 so that fine contaminants are separated from the semi-clean air by centrifugal force operating upon the whirling semi-clean air. Then, the second cyclone unit 50 discharges clean air having fine contaminants removed to the vacuum generator 131 (see FIG. 7). Here, the semi-clean air contains fine contaminants that are not removed in the first cyclone unit 10, and the second cyclone unit 50 removes fine contaminants from the semi-clean air by centrifugal force.

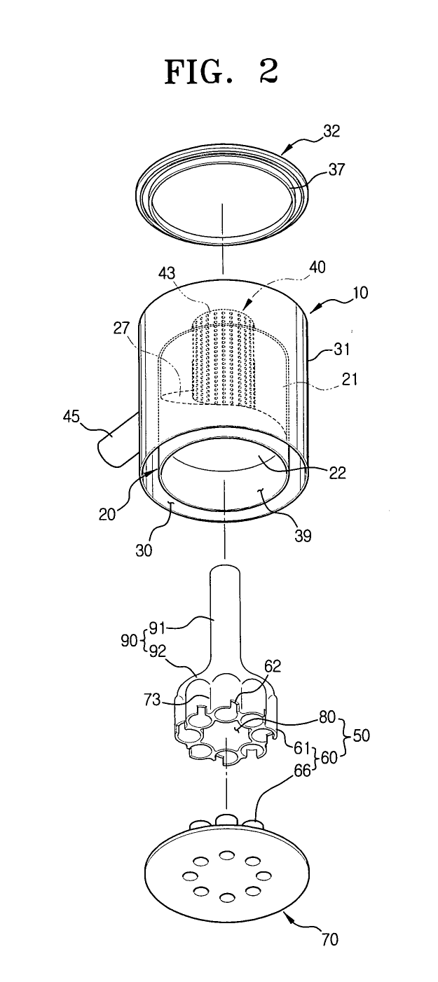

Referring to FIGS. 2 to 5, the second cyclone unit 50 includes a plurality of second cyclones 60, and a second contaminants chamber 80.

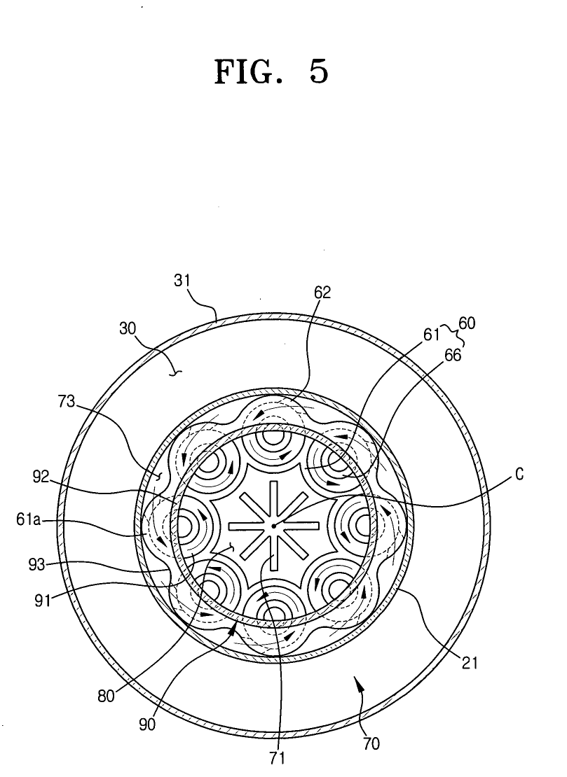

The plurality of second cyclones 60 is disposed under the first cyclone unit 10. Each of the plurality of second cyclones 60 sucks the semi-clean air discharged from the first cyclone unit 10 through a lower portion of the second cyclone 60, and then, forms the semi-clean air into an upwardly whirling air current. Fine contaminants are centrifugally separated from the semi-clean air by centrifugal force operating upon the upwardly whirling air current, and clean air is discharged from each of the plurality of second cyclones 60 to the vacuum generator 131. At this time, the plurality of second cyclones 60 is disposed in a substantially circular shape inside the sidewall 21 of the first cyclone body 20 as shown in FIG. 5. In this embodiment, eight (8) second cyclones 60 are arranged in a substantial circle based on a center axis C of the contaminants discharging member 90.

Each of the plurality of second cyclones 60 includes a second cyclone body 61 and an air-discharging pipe 66. The second cyclone body 61 is formed in a substantially hollow cylindrical shape with an opened top end and a closed bottom end. Some part 61a of at least one second cyclone body 61 is projected out beyond a circumferential surface 93 of the contaminants discharging member 90. In this embodiment, some part 61a of each of the plurality of second cyclone bodies 61 is projected out beyond a circumferential surface 93 of the contaminants discharging member 90 as shown in FIGS. 2 and 5. Each of the plurality of second cyclone bodies 61 is disposed to contact to the next second cyclone body 61. An under portion of the contaminants discharging member 90 is formed to cover an upper side of the projected part 61a of each of the plurality of second cyclone bodies 61. Therefore, a space between 2 nearby second cyclone bodies 61 and the sidewall 21 of the first cyclone body 20 forms an air pathway 73 of the semi-clean air flowing along the outside surface 92a of the contaminants discharging member 90. Also, a second air suction port 62 is formed at the lower portion of the second cyclone body 61 corresponding to an end of the air pathway 73. Therefore, the semi-clean air that is passed the air pathway 73 is entered inside the second cyclone body 61 through the second air suction port 62 so as to form an upwardly whirling air current.

The air-discharging pipe 66 is formed in a substantially hollow cylindrical shape and is disposed to project upwardly on a center of the bottom surface of the second cyclone body 61 and in fluid communication with the vacuum generator 131. The air-discharging pipe 66 has opposite opened ends. A top end of the air-discharging pipe 66 is lower than a top end of the second cyclone body 61. Therefore, clean air having fine contaminants removed inside the second cyclone body 61 by centrifugal force is discharged to the vacuum generator 131 through the air-discharging pipe 66. Although not shown, an air gathering member may be disposed under the plurality of air-discharging pipes 66 so as to gather air being discharged through each of the plurality of air-discharging pipes 66 and to guide to the vacuum generator 131.

The second contaminants chamber 80 is formed as a space wrapped around by the plurality of second cyclones 60 to collect fine contaminants discharged from each of the plurality of second cyclones 60. In other words, the plurality of second cyclone bodies 61 that is disposed in a substantially circular shape forms a side surface of the second contaminants chamber 80 and the bottom cover 70 forms a bottom surface of the second contaminants chamber 80. The second contaminants chamber 80 has a blocking wall 71 that is disposed on a center of the bottom cover 70 to prevent contaminants collected in the second contaminants chamber 80 from moving.

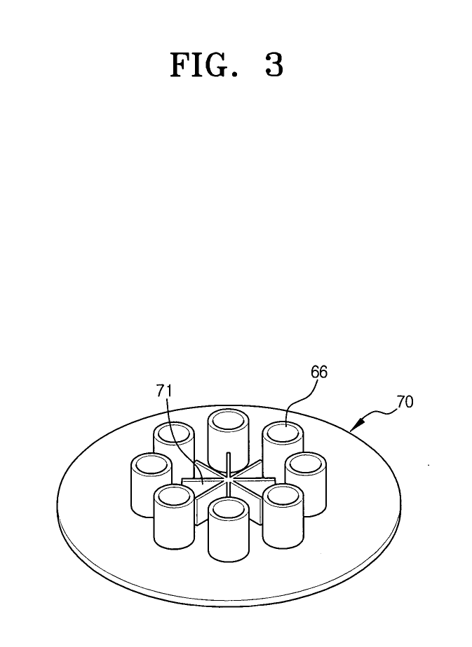

The bottom cover 70 closes the bottom ends of the first contaminants receptacle 31 and the first cyclone body 20 thereby forming bottom surfaces of the first and second contaminants chambers 30 and 80. Also, preferably, the air-discharging pipe 66 of each of the plurality of second cyclones 60 is formed in one body with the bottom cover 70 as shown in FIG. 3, so that the bottom cover 70 forms a bottom surface of each of the second cyclone bodies 61. That the bottom cover 70 is formed integrally with the plurality of air-discharging pipes 66 as described above causes injection molding easy.

The contaminants discharging member 90 is disposed over the second cyclone unit 50 and inside the air communicating member 40 so as to discharge fine contaminants separated in the second cyclone unit 50 to an upper side of the air communicating member 90. The contaminants discharging member 90 is substantially funnel shaped and includes a contaminants gathering part 92 and a discharging part 91. The contaminants gathering part 92 is disposed under the air communicating member 40 in a substantially dome shape covering the upper side of the plurality of second cyclones 60. When the multi-cyclone dust collector 1 is turned upside down, the contaminants gathering part 92 gathers contaminants falling from the second contaminants chamber 80, and then, discharges the contaminants into the discharging part 91. The discharging part 91 is disposed inside the air communicating member 40. A top end of the discharging part 91 is extended to the top end 41 of the air communicating member 40 and a bottom end of the discharging part 91 is in fluid communication with a top end of the contaminants gathering part 92. It is preferable that the discharging part 91 is formed in a substantially cylindrical shape and has the same center as the air communicating member 40. The discharging part 91 discharges contaminants collected on the contaminants gathering part 92 to the upper side of the air communicating member 40. Therefore, when the multi-cyclone dust collector 1 is turned upside down, contaminants collected in the second contaminants chamber 80 move to the upper cover 32 through the contaminants discharging member 90.

Furthermore, the outside surface 92a of the contaminants discharging member 90 guides the semi-clean air entered into the air communicating member 40 to each of the plurality of second cyclones 60. In other words, the semi-clean air flows along the outside surface 92a of the contaminants gathering part 92 of the contaminants discharging member 90, and then, is distributed into each of the plurality of air pathways 73 between the plurality of second cyclone bodies 61 and the sidewall 21 of the first cyclone body 20, thereby entering the second air suction port 62 of each of the plurality of second cyclone bodies 61. On the other hand, when the contaminants discharging member 90 is made by an injection molding, it is preferable that the contaminants discharging member 90 is integrally formed with the plurality of second cyclone bodies 61 as shown in FIG. 2.

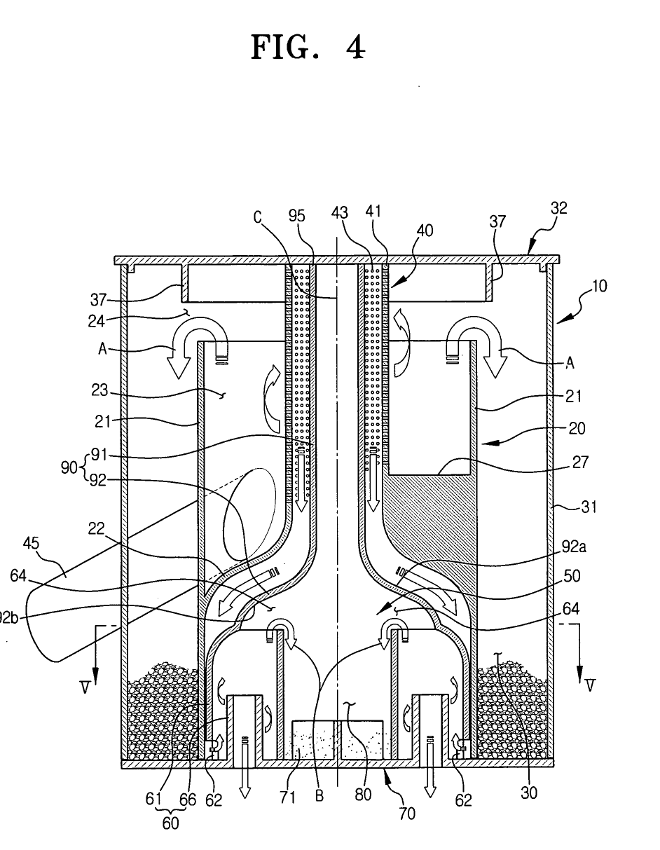

Preferably, the partition wall 22 of the first cyclone body 20 is formed in a dome shape corresponding to the contaminants gathering part 92 of the contaminants discharging member 90 so that the semi-clean air smoothly flows between the partition wall 22 of the first cyclone body 20 and the contaminants discharging member 90. In other words, the partition wall 22 of the first cyclone body 20 is disposed to keep a predetermined distance from the outside surface 92a of the contaminants gathering part 92 of the contaminants discharging member 90 as shown in FIG. 4.

Hereinafter, operation of the multi-cyclone dust collector 1 for the vacuum cleaner according to an embodiment of the present invention is explained with reference to accompanying drawings.

Upon turning on the vacuum cleaner, the vacuum generator 131 (see FIG. 7) operates to generate a suction force. The suction force sucks contaminants-laden air into the suction brush 110 (see FIG. 7) from a cleaning surface. The contaminants-laden air sucked into the suction brush 110 flows to a multi-cyclone dust collector 1 in fluid communication with the suction brush 110 via one or more connection members 121 and 122 (see FIG. 7).

The contaminants-laden air flowing into the multi-cyclone dust collector 1 enters the first cyclone body 20 through the air suction pipe 45 of the first cyclone unit 10. The contaminants-laden air entered through the air suction pipe 45 forms an upwardly whirling air current that whirls and flows upwardly inside the first cyclone body 20. At this time, the contaminants-laden air easily forms the upwardly whirling air current due to the sloping surface 27 disposed before the air suction pipe 45 on the partition wall 22 inside the first cyclone body 20. Then, contaminants are separated from the contaminants-laden air by centrifugal force operating on the upwardly whirling air current. The separated contaminants are discharged into the first contaminants chamber 30 through the contaminants discharge opening 24 between the top end of the first cyclone body 20 and the upper cover 32 as illustrated by arrow A in FIG. 4, and are collected in the first contaminants chamber 30. The first contaminants chamber 30 is isolated from a space 23 of the upwardly whirling air current by the sidewall 21 of the first cyclone body 20 so that the contaminants collected in the first contaminants chamber 30 do not affect the upwardly whirling air current inside the first cyclone body 20. Also, air that forms an upwardly whirling air current inside the first cyclone body 20 is directly discharged through the plurality of air discharging holes 43 of the air communicating member 40 so that air collision does not occur inside the first cyclone body 20. Therefore, contaminants collecting efficiency of the multi-cyclone dust collector 1 according to the present invention is increased.

The semi-clean air having contaminants removed in the first cyclone body 20 flows to the second cyclone unit 50 through the plurality of air discharging holes 43 of the air communicating member 40. The contaminants discharging member 90 is disposed inside the air communicating member 40 so that the semi-clean air flows a space between an inner surface of the air communicating member 40 and an outside surface 92a of the discharging part 91 of the contaminants discharging member 90. The semi-clean air passed through the air communicating member 40 flows along the outside surface 92a of the contaminants gathering part 92 of the contaminants discharging member 90, and then, is distributed to each of the plurality of air pathways 73 under the contaminants gathering part 92, thereby entering the second air suction port 62 of each of the plurality of second cyclones 60.

The semi-clean air entered through the second air suction port 62 forms an upwardly whirling air current inside the second cyclone body 61. Then, fine contaminants are separated from the semi-clean air by centrifugal force operating upon the upwardly whirling air current. The separated fine contaminants is discharged to and collected in the second contaminants chamber 80 through a gap between an inside surface 92b of the contaminants gathering part 92 of the contaminants discharging member 90 and the top end of the second cyclone body 61 as illustrated by arrow B in FIG. 4. At this time, the second contaminants chamber 80 is isolated by the second cyclone body 61 so that the fine contaminants collected in the second contaminants chamber 80 do not affect the upwardly whirling air current inside the second cyclone body 61. Also, air forming an upwardly whirling air current inside the second cyclone body 61 is directly discharged through the air-discharging pipe 66 so that air collision does not occur inside the second cyclone body 61. Therefore, contaminants collecting efficiency is increased.

Clean air having fine contaminants removed in the second cyclone body 61 is discharged through the air-discharging pipe 66. In each of the plurality of second cyclone bodies 61, clean air after having fine contaminants removed from the semi-clean air by above-described operation is discharged through the air-discharging pipe 66. The air discharged through each of the air-discharging pipes 66 passes through the vacuum generator 131, and then, is discharged out of the main body 130 of the vacuum cleaner.

If the air gathering member (not shown) is disposed under the plurality of air-discharging pipes 66, clean air discharged through the air-discharging pipe 66 of each of the second cyclones 60 is gathered by the air gathering member to be discharged to the vacuum generator 131.

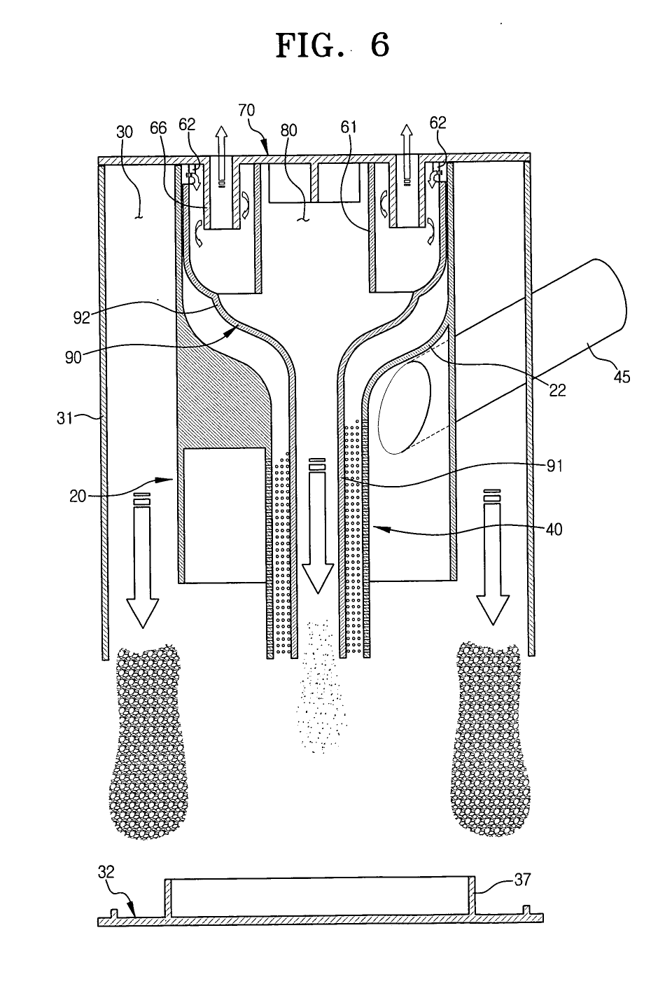

When the first contaminants chamber 30 or/and the second contaminants chamber 80 is full, the first and second contaminants chambers 30 and 80 can be emptied. When emptying the first and second contaminants chambers 30 and 80, a user first opens the upper cover 32 that covers the first contaminants chamber 30 and the top end 95 of the contaminants discharging member 90. Thereafter, the user turns the multi-cyclone dust collector 1 upside down as shown FIG. 6 so that contaminants collected in each of the first and second contaminants chambers 30 and 80 can be dumped out. At this time, fine contaminants collected in the second contaminants chamber 80 are discharged outside along the inside surfaces 92b of the contaminants gathering part 92 and the discharging part 91 of the contaminants discharging member 90. The structure of the multi-cyclone dust collector 1 of which the upper cover 32 is opened to empty collected contaminants lets a user to watch contaminants discharged from the multi-cyclone dust collector 1 so that it is more convenient to empty contaminants than the structure of the multi-cyclone dust collector of which a bottom cover 70 is opened to empty contaminants.

Furthermore, the multi-cyclone dust collector 1 according to an embodiment of the present invention has the backflow preventing dam 37 disposed on the upper cover 32, thereby preventing contaminants collected in the first contaminants chamber 30 from flowing back into the first cyclone body 20 through the contaminants discharging opening 24.

Hereinafter, an example of a vacuum cleaner 100 employing a multi-cyclone dust collector 101 according to the present invention is explained.

Referring to FIG. 7, the vacuum cleaner 100 according to an embodiment of the present invention includes a suction brush 110, an extension pipe 121, a flexible hose 122, and amain body 130.

The suction brush 110 has at bottom surface a contaminants suction opening (not shown) that sucks contaminants-laden air from a cleaning floor.

The extension pipe 121 and the flexible hose 122 make the suction brush 110 in fluid communication with the main body 130. A handle 120 is disposed at an upper portion of the extension pipe 121. A power switch 123 turning on the vacuum cleaner 100 is generally disposed on the handle 120.

The main body 130 includes a vacuum generator 131 and a multi-cyclone dust collector 101. The vacuum generator 131 generates a suction force to suck contaminants-laden air via the suction brush 110, and is in fluid communication with the multi-cyclone dust collector 101. The multi-cyclone dust collector 101 separates and collects contaminants from the sucked contaminants-laden air. The multi-cyclone dust collector 101 employs a first cyclone unit that separates and collects comparatively large contaminants, and a second cyclone unit that separates and collects fine contaminants by centrifugal force operating upon an upwardly whirling air current. The structure and operation of the multi-cyclone dust collector 101 is the same as the multi-cyclone dust collector 1 described above, so a detailed description thereof is not repeated for conciseness.

Therefore, upon turning on the vacuum cleaner 100 and then moving the suction brush 110, contaminants on a cleaning floor are sucked into the contaminants suction opening of the suction brush 110 by the suction force of the vacuum generator 131. The contaminants sucked through the contaminants suction opening enter the multi-cyclone dust collector 101 through the extension pipe 121 and the flexible hose 122. The contaminants entered the multi-cyclone dust collector 101 are separated and collected by the first and second cyclone units 10 and 50 (see FIG. 4). Clean air discharges out of the main body 130.

In the above description, a canister type vacuum cleaner is used as an example of vacuum cleaners employing the multi-cyclone dust collector according to an embodiment of the present invention; however, this should not be considered as limiting. Various types of vacuum cleaners such as an upright type vacuum cleaner may employ the multi-cyclone dust collector according to an embodiment of the present invention.

While the embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

What is claimed is:

1. A multi-cyclone dust collector for a vacuum cleaner comprising:
a first cyclone unit forcing contaminants-laden air to form an upwardly whirling air current so as to centrifugally separate contaminants from the contaminants-laden air, the first cyclone unit having an air communicating member;
a second cyclone unit being disposed under the first cyclone unit, the second cyclone unit forcing partially cleaned air discharged through the air communicating member to be sucked into a lower portion of the second cyclone unit and to form a second upwardly whirling air current so as to centrifugally separate fine contaminants from the partially cleaned air, the second cyclone unit having a plurality of second cyclones; and
a contaminants discharging member being disposed over the second cyclone unit inside the air communicating member for discharging the fine contaminants separated in the second cyclone unit to an upper side of the air communicating member.

2. The multi-cyclone dust collector of claim 1, wherein the first cyclone unit further comprises:
a first cyclone body being formed in a substantially hollow cylindrical shape, inside which the contaminants-laden air whirls;
a first contaminants chamber wrapping around the first cyclone body to collect contaminants discharged from the first cyclone body; and
an air suction pipe being disposed at a lower portion of the first cyclone body to form the contaminants-laden air into the upwardly whirling air current.

3. The multi-cyclone dust collector of claim 2, wherein the air suction pipe is disposed to be tangential to the first cyclone body in an upwardly inclined direction and in fluid communication with the first cyclone body.

4. The multi-cyclone dust collector of claim 2, wherein the first cyclone body further comprises a contaminants discharging opening that is formed at an upper portion of a sidewall of the first cyclone body to discharge contaminants separated from the contaminants-laden air to the first contaminants chamber.

5. The multi-cyclone dust collector of claim 2, wherein the second cyclone unit further comprises a second contaminants chamber, the plurality of second cyclones wrapping around the second contaminants chamber to collect the fine contaminants discharged from the plurality of second cyclones.

6. The multi-cyclone dust collector of claim 5, wherein each of the plurality of second cyclones comprises:
a second cyclone body being formed in a substantially hollow cylindrical shape with a closed bottom end, the second cyclone body having a second air suction port that is disposed at a lower portion of the second cyclone body for the partially cleaned air to enter; and
an air-discharging pipe being projected upwardly on a center of a bottom surface of the second cyclone body to discharge clean air having the fine contaminants removed in the second cyclone body.

7. The multi-cyclone dust collector of claim 6, wherein the plurality of second cyclone bodies and the contaminants discharging member are formed integrally by an injection molding process.

8. The multi-cyclone dust collector of claim 1, wherein the contaminants discharging member comprises:
a contaminants gathering part being disposed under the air communicating member to cover the plurality of second cyclones in a dome shape; and
a discharging part being disposed inside the air communicating member, the discharging part having a top end to be extended to the top end of the air communicating member and a bottom end in fluid communication with the contaminants gathering part.

9. The multi-cyclone dust collector of claim 1, further comprising:
an upper cover detachably covering a top end of the first cyclone unit.

10. A multi-cyclone dust collector for a vacuum cleaner comprising:
a first cyclone unit having at least one first cyclone for separating contaminants from outside air; and
a second cyclone unit having at least one second cyclone for separating fine contaminants from partially cleaned air discharged from the first cyclone unit, the second cyclone unit being disposed inside the at least one first cyclone of the first cyclone unit, wherein bottom surfaces of the first and second cyclone units are located on the same horizontal plane.

11. The multi-cyclone dust collector of claim 10, wherein the second cyclone unit comprises a plurality of second cyclones arranged in a substantially circular shape,
wherein contaminants separated in the at least one first cyclone are discharged outside a circumferential surface of the at least one first cyclone,
wherein fine contaminants separated in each of the plurality of second cyclones are discharged to a space wrapped around by the plurality of second cyclones.

12. The multi-cyclone dust collector of claim 10, wherein each of the at least one first cyclone and the at least one second cyclone force air to be entered into a side of a lower portion thereof and to be discharged through a center of the lower portion thereof.
